(19) United States
(12) Patent Application Publication
(10) Pub. No.: US 2024/0402699 A1
(43) Pub. Date: Dec. 5, 2024

(54) APPARATUSES, COMPUTER-IMPLEMENTED METHODS, AND COMPUTER PROGRAM PRODUCTS FOR IMPROVED MAINTENANCE IDENTIFICATION AND SCHEDULING

(71) Applicant: Honeywell International Inc., Charlotte, NC (US)

(72) Inventors: Jayalaxmi Vaman TELANG, Bangalore (IN); Karthika MURUGESAN, Mumbai (IN); Murugan GOPALAN, Bengaluru (IN); Ronny SCHERF, Grosshennersdorf (DE)

(21) Appl. No.: 18/325,700

(22) Filed: May 30, 2023

(51) Int. Cl. G05B 23/02

(52) U.S. Cl. CPC G05B 23/0283; G05B 23/0227

(57) ABSTRACT

Embodiments provide improved determinations of maintenance to be performed for asset(s), and scheduling of such maintenance to initiate for the asset(s), for example in an industrial control system. Some embodiments receive particular input data including (i) alert history data corresponding to an asset, (ii) maintenance standards data corresponding to the asset, (iii) service history data corresponding to the asset, and (iv) user-specific data corresponding to the asset, apply the input data to an intelligence machine learning model that generates a maintenance schedule based at least in part on the input data, and outputs a particular maintenance schedule corresponding to the asset via output from the intelligence machine learning model based at least in part on the input data.

### TECHNICAL FIELD

Embodiments of the present disclosure generally relate to improved maintenance of assets, and specifically to automatically generating an improved maintenance schedule for performing maintenance events of a particular asset.

### BACKGROUND

Over time, an asset in an industrial plant or system may experience one or more issues, malfunctions, or other problems affecting performance of the asset. To ensure an asset remains performing as desired, maintenance of the asset may be performed. Maintenance often is performed at a particular scheduled time and may impact an overall process that utilizes the asset during the time when maintenance is performed and/or require expenditure of resources to perform the maintenance.

Applicant has discovered problems with current implementations of generating maintenance schedules and data associated therewith for a particular asset. Through applied effort, ingenuity, and innovation, Applicant has solved many of these identified problems by developing embodied in the present disclosure, which are described in detail below.

### BRIEF SUMMARY

In one aspect, a computer-implemented method for generating a dynamic maintenance schedule for assets includes receiving input data includes (i) alert history data corresponding to an asset, (ii) maintenance standards data corresponding to the asset, (iii) service history data corresponding to the asset, and (iv) user-specific data corresponding to the asset, applying the input data to an intelligence machine learning model that generates a maintenance schedule based at least in part on the input data, and outputting a particular maintenance schedule corresponding to the asset via output from the intelligence machine learning model based at least in part on the input data.

The computer-implemented method may also include where the input data includes asset metadata comprising metadata associated with the asset or metadata associated with at least one part of the asset.

The computer-implemented method may also include where the particular maintenance schedule indicates at least one subcomponent of the asset indicated to receive maintenance, and where the particular maintenance schedule particular timestamp data indicating a time at which maintenance of the asset is to be performed.

The computer-implemented method may also include where the intelligence machine learning model further outputs at least one narrative associated with the maintenance schedule, where the at least one narrative includes first text data indicating a first reason for deviating at least one maintenance event in the maintenance schedule from the maintenance standards data, second text data indicating a second reason for an arrangement of maintenance events represented in the maintenance schedule, or a combination of the first text data and the second text data.

The computer-implemented method may also include where the intelligence machine learning model further generates a maintenance item list corresponding to the asset.

The computer-implemented method may further include generating an advance notification corresponding to an upcoming maintenance event represented in the particular maintenance schedule.

The computer-implemented method may further include automatically flagging at least one performance metric associated with the asset as untrustworthy during a maintenance period associated with the asset, where the maintenance period is represented by the particular maintenance schedule.

The computer-implemented method may further include automatically toggling activation of at least one alert generation rule based at least in part on the particular maintenance schedule.

The computer-implemented method may further include automatically initiating at least one maintenance action associated with the asset.

The computer-implemented method may also include where the intelligence machine learning model includes at least one natural language processing model that determines at least a portion of the user-specific data corresponding to the asset based at least in part on text data stored by a user associated with the asset.

The computer-implemented method may also include where the intelligence machine learning model includes at least one natural language processing model that generates the at least one narrative in a natural language format.

In another aspect, an apparatus is provided. The apparatus includes at least one processor and at least one non-transitory memory having computer-coded instructions stored thereon that, in execution with the at least one processor causes the apparatus to perform any one of the example computer-implemented methods described herein.

In another aspect, a computer program product is provided. The computer program product includes at least one non-transitory computer-readable storage medium having computer program code stored thereon that, in execution with at least one processor, configures the computer program product to perform any One of the example computer-implemented methods described herein.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of a system in which embodiments of the present disclosure may operate.

FIG. 2 illustrates a schematic diagram of an apparatus in accordance with at least one embodiment of the present disclosure.

FIG. 3 illustrates a data flow for generating an asset alert in accordance with at least one embodiment of the present disclosure.

FIG. 4 illustrates a data flow for generating a service record in response to a performed maintenance event in accordance with at least one embodiment of the present disclosure.

FIG. 5 illustrates a data flow for generating a maintenance schedule in accordance with at least one embodiment of the present disclosure.

FIG. 6 illustrates a visualization of an example maintenance schedule in accordance with at least one embodiment of the present disclosure.

FIG. 7 illustrates a visualization of various example data generable via an intelligence machine learning model in accordance with at least one embodiment of the present disclosure.

FIG. 8 illustrates operations of an example process in accordance with at least one embodiment of the present disclosure.

### OVERVIEW

In various contexts, one or more assets interact to perform an industrial process. For example, one or more assets of an industrial plant may include any number of robots, machinery, computing devices, and/or the like that manipulates physical ingredients, data, and/or the like. In some such contexts, the assets may be monitored by one or more sensors, systems, and/or the like. For example, in various circumstances, a central monitoring system may track key performance metrics associated with operation of one or more assets based on sensor data, analog detected data, and/or digital data representing such operational aspects of the one or more assets. In this regard, assets may be monitored to determine how a particular asset, or group of assets, is performing, and/or whether the particular asset is functioning as desired or intended.

Often, performance of an asset degrades over time for any of a myriad of reasons. To avoid significant performance decreases in the performance of the asset, or even a catastrophic failure completely preventing operation of the asset, maintenance may be performed on a particular asset. Performance of maintenance itself, however, causes multiple problems for the operator of such assets and/or associated industrial process to which that asset contributes. For example, in various circumstances maintenance of an asset requires that the asset be non-functional, or at least partially non-functional (e.g., operating in a degraded state) for a particular period of time during which maintenance occurs. Additionally or alternatively, maintenance of a particular asset often requires resource expenditure by the operator and/or owner of the asset, for example by assigning human resources to perform the maintenance, incurring costs for replacement components of the asset to utilize during maintenance, and/or the like. In this regard, balancing the positive aspects of performing maintenance on an asset with the corresponding negative aspects of performing such maintenance on the asset is appropriate to avoid performing maintenance at the expense of ongoing operations and resources when such maintenance does not provide a sufficient benefit to performance of the asset. Though existing maintenance standards may be created and/or utilized for a particular asset, asset type, and/or the like, such maintenance standards are agnostic to the operations of an individual asset, such that the maintenance standards often are inaccurate with respect to any one particular asset. Thus, simple maintenance scheduling and related operations remain insufficient and with significant technical problems for efficiently and effectively generating maintenance schedules for one or more assets.

Embodiments of the present disclosure provide for generation of an improved maintenance schedule. In some embodiments, the improved maintenance schedule is generated for at least one asset. The improved maintenance schedule dynamically determines maintenance events and corresponding maintenance periods for such maintenance events based on actual data associated with the asset. Some embodiments utilize a specially trained model, for example an intelligence machine learning model specially trained to generate an accurate maintenance schedule based on the data associated with the asset. Such data associated with a particular asset may include alert history data representing any number of asset alerts previously triggered associated with the asset, service history data representing records of previously performed maintenance events, user-specific data representing user override or other notes associated with maintenance of an asset, and/or maintenance standards data defining predetermined or generally accepted maintenance schedule configuration associated with the asset. Such data in some embodiments are predetermined, and/or in some embodiments are generated and/or tracked during operation of the asset or a group of assets.

In this regard, embodiments utilize the intelligence machine learning model to generate a particular maintenance schedule that indicates maintenance events to be performed at particular times represented by corresponding maintenance periods. The particular maintenance schedule accurately indicates what maintenance actions should be performed for a particular asset and when such maintenance actions should be performed. Specifically, such an improved particular maintenance schedule to improves the performance of the maintenance events at a particular times to improve the benefits of such maintenance without sacrificing significant performance hits to operation of the asset while simultaneously or alternatively reducing waste of maintenance that would conventionally be performed based on maintenance standards but may not be beneficial for a particular asset. Thus, embodiments of the present disclosure ensure maintenance is performed to keep an asset performing desirably with such reduced resource expenditure.

Some embodiments provide any of a myriad of additional advantageous outputs via the intelligence machine learning model. Some embodiments generate one or more narratives associated with a particular maintenance schedule, where the narratives provide human-readable insight into adjustments to maintenance standards that are represented in the generated particular maintenance schedule. Such narratives advantageously enable users to reconfigure the asset, systems, and/or perform any of a myriad of other actions based on such narratives that are conventionally not available for a specific asset.

Additionally or alternatively, some embodiments generate one or more advance notifications. Each advance notification indicates an upcoming maintenance event scheduled in a particular maintenance schedule at a particular maintenance period that is upcoming in the future (e.g., within a particular timestamp interval). In this regard, such embodiments keep users associated with initiating or performing such maintenance informed to ensure that such maintenance can be performed in a timely manner.

Additionally or alternatively, some embodiments generate a maintenance item list for a particular maintenance event corresponding to a particular asset. A maintenance item list in some such embodiments includes particular maintenance actions to be performed during a particular maintenance event during a particular corresponding maintenance period. In this regard, the maintenance item list enables guidance of particular maintenance actions at particular times where such maintenance actions will be worthwhile to improve performance of the asset given the resource expenditure of such maintenance actions. Additionally or alternatively, in some embodiments the maintenance item list provides a checklist of actions for a maintenance engineer or other user to follow during a scheduled maintenance event.

Additionally or alternatively, some embodiments adjust trustworthiness of performance metric calculation and/or visualization corresponding to a particular action. Some embodiments automatically flag particular performance metrics as untrustworthy during particular maintenance periods indicated in the generated particular maintenance schedule. In this regard, such embodiments advantageously enable such data to be ignored, skipped, or otherwise alternatively processed during such maintenance periods, for example without triggering particular concerns and/or data-driven processes based on such untrustworthy performance metrics.

Additionally or alternatively, some embodiments toggle activation of alert generation rules based on a particular generated maintenance schedule. Some embodiments automatically deactivate an alert generation rule during a maintenance period of a particular maintenance event represented in a generated particular maintenance schedule. In this regard, such embodiments advantageously prevent such an alert generation rule from improperly triggering during the maintenance. Additionally or alternatively, some embodiments automatically activate or reactivate an alert generation rule upon completion of a maintenance period of a particular maintenance event represented in a generated particular maintenance schedule. In this regard, such embodiments advantageously reconfigure such systems to return to accurately monitoring for asset alerts automatically once maintenance of an asset is completed.

### Definitions

“Activation” with respect to an alert generation rule refers to a state of whether the alert generation rule is utilized to actively process data and/or generate an asset alert based on such data.

“Advance notification” refers to electronically managed data embodying an audio, visual, and/or textual data indicating a maintenance event to be performed at a future timestamp.

“Alert generation rule” refers to one or more defined data-driven comparisons, determinations, and/or other triggers that indicate problematic, non-typical, or other malfunctioning operation of an asset based on operational data associated with that asset.

“Alert history data” refers to electronically managed data representing any asset alerts generated based on operation of the asset and/or related assets.

“Arrangement of maintenance events” refers to a schedule of maintenance events, each maintenance event associated with timestamp data defining a maintenance period during which a particular asset is to be maintained.

“Asset” refers to any machine, robot, computing device, and/or industrial control system that contributes to an industrial process.

“Asset alert” refers to electronically managed data generated in response to an alert generation rule based on operational data associated with operation of an asset.

“Intelligence machine learning model” refers to a machine learning model specially trained to learn a maintenance schedule optimized for a particular asset based on data associated with that asset.

“Maintainer” refers to a user, human, or other entity that performs at least a portion of physical and/or remote maintenance for a particular asset.

“Maintenance action” refers to an automatic or manual action performable to maintain the asset in a properly functioning or desired operational manner.

“Maintenance event” refers to a scheduled indication of one or more maintenance actions to be performed during a particular maintenance period.

“Maintenance item list” refers to electronically managed data representing one or more determinable parameter(s) or that are processable to determine whether an asset is operating normally or in an alternative state requiring maintenance.

“Maintenance period” refers to timestamp data indicating a time or period of time at which maintenance of an asset is to occur.

“Maintenance schedule” refers to electronically managed data indicating any number of maintenance events to be performed at any number of corresponding maintenance periods.

“Maintenance standards data” refers to electronically managed data representing standard, default, and/or generally accepted maintenance standards for a particular asset.

“Narrative” refers to human-interpretable data indicating a reason for a particular decision, generated data, trigger, or other result of a data process. In some contexts a narrative provides a reason for generation of particular maintenance events in a maintenance schedule and/or a deviation of a maintenance schedule from maintenance standards data.

“Natural language format” refers to electronically managed text data that is presented in a contextual domain understandable to one or more human users.

“Natural language processing model” refers to a specially trained model that generates text data in one or more natural language formats and/or processes text data of one or more natural language formats.

“Operational data” refers to electronically managed data indicating a status of operation of a particular monitored aspect of an asset during operation of the asset.

“Performance metric” refers to a particular value for a particular monitored aspect of operational data.

“Service history data” refers to electronically managed data representing previously performed maintenance events for a particular asset.

“Service record” refers to electronically managed data representing previously performed maintenance corresponding to a particular maintenance event for a particular asset. In some contexts, a service record includes data indicating maintenance actions performed by a particular maintainer during a particular maintenance event performed at or during a particular maintenance period.

“Subcomponent” refers to any submachine, system, part, or other related machine that is upstream from, downstream from, or otherwise contributes to operation of an asset.

“Timestamp data” refers to electronically managed data representing a particular time or range of times.

“Untrustworthy” refers to a state associated with collected data indicating that the collected data may not accurately reflect operation of an asset due to abnormal performance associated with a maintenance event.

“User-specific data” refers to electronically managed data indicating additional data or override data that indicates a preferred methodology for generating a maintenance schedule, or a portion thereof, associated with a particular asset or group of assets as defined by one or more entities.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### EXAMPLE SYSTEMS AND APPARATUSES OF THE DISCLOSURE

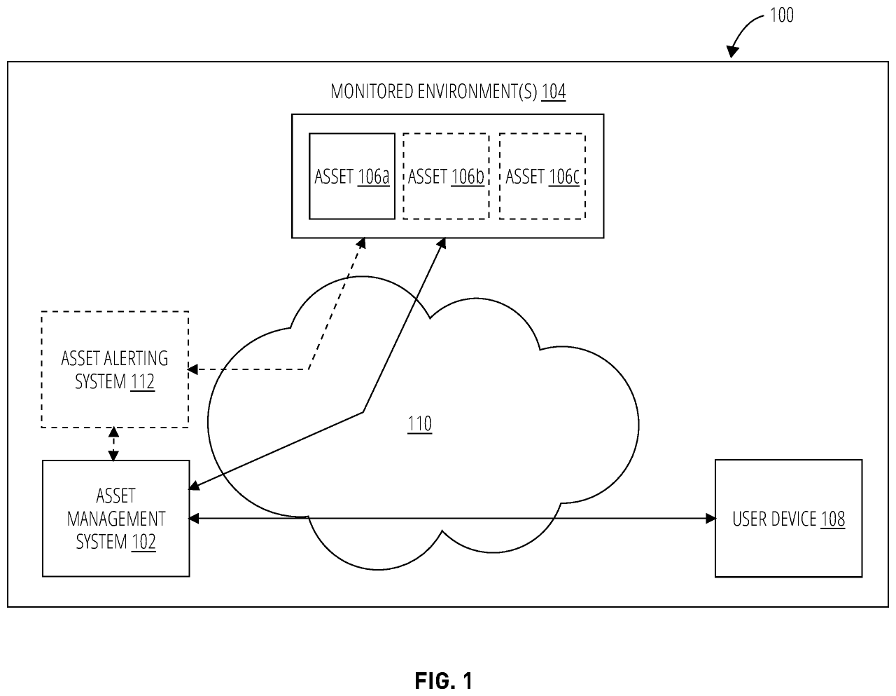

FIG. 1 illustrates a block diagram of a system in which embodiments of the present disclosure may operate. Specifically, FIG. 1 depicts an example system 100. As illustrated, the system 100 includes an asset management system 102, one or more asset 106a-106c located in a monitored environment(s) 104, and user device 108. The system 100 optionally includes a separate asset alerting system 112. Alternatively or additionally, in some embodiments, the asset management system 102 embodies or includes some or all of the asset alerting system 112, such that the asset management system 102 and asset alerting system 112 embody a single computing device or system. In some embodiments, the system 100 includes at least one communications network 110. The communications network 110 enables communication between the asset management system 102, one or more of the assets embodied by asset 106a-106c, and/or user device 108. Additionally or alternatively, in some embodiments, the communications network 110 communicatively couples the asset alerting system 112 with the asset management system 102.

It should be appreciated that the communications network 110 in some embodiments is embodied in any of a myriad of network configurations. In some embodiments, the communications network 110 embodies a public network (e.g., the Internet). In some embodiments, the communications network 110 embodies a private network (e.g., an internal localized, or closed-off network between particular devices). In some other embodiments, the communications network 110 embodies a hybrid network (e.g., a network enabling internal communications between particular connected devices and external communications with other devices). The communications network 110 in some embodiments includes one or more base station(s), relay(s), router(s), switch(es), cell tower(s), communications cable(s) and/or associated routing station(s), and/or the like. In some embodiments, the communications network 110 includes one or more user controlled computing device(s) (e.g., a user owned router and/or modem) and/or one or more external utility devices (e.g., Internet service provider communication tower(s) and/or other device(s)).

Each of the components of the system 100 communicatively coupled to transmit data to and/or receive data from one another over the same or different wireless and/or wired networks embodying the communications network 110. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 110, the various embodiments are not limited to this architecture. Additionally or alternatively, one or more other devices may perform the communication associated with a particular computing device. For example, in some embodiments, an asset is associated with one or more sensors, where the sensors communicate data (e.g., operational data) associated with the asset to the asset management system 102. In other embodiments, one or more computing entities share one or more components, hardware, and/or the like, or otherwise are embodied by a single computing device such that connection(s) between the computing entities are over the communications network 110 are altered and/or rendered unnecessary.

In some embodiments, the asset management system 102 is/are embodied in an on-premises system within or associated with a particular monitored environment. For example, in some embodiments the asset management system 102 is a local system within the monitored environment(s) 104 associated with the one or more assets 106a-106c. In some embodiments, the on-premises system embodied by the monitored environment(s) 104 is communicatively coupled to one or more of the assets 106a-106c via at least one wired device. Additionally or alternatively, one or more of such systems may be remote from one another, for example where the assets 106a-106c are within one or more monitored environment(s) 104 being monitored by sensors of or associated with the assets 106a-106c, and where the asset management system 102 is a cloud system or otherwise remotely located from the monitored environment(s) 104.

An asset, for example one or more of the assets 106a-106c includes any number of computing device(s), system(s), robot(s), machinery, and/or the like, that contribute towards at least a portion of a particular industrial process. For example, in some embodiments, the assets 106a-106c define individual processing units that each perform a sub-step of the industrial process. In one example context, the assets 106a-106c embody physical components embodying processing units, tanks, pipes, and/or control systems, of an oil refinery that processes crude oil and/or other input products to produce a particular desired target product. In another context, the assets 106a-106c embody components of a chemical plant, manufacturing facility, building, and/or the like that performs one or more process(es) via the assets 106a-106c that are monitorable via data capture, as described herein. Non-limiting examples of an asset, for example one of the assets 106a-106c includes a hydrocracker, a blender, a storage tank, a visbreaker, and the like (e.g., in an oil refining context), a security system, HVAC unit, gas utility system, electric utility system, and water utility system (e.g., in a building management context), and/or the like. It should be appreciated that a particular monitored environment may include any number of assets, where operational data is detectable, trackable, and/or otherwise determined based on the operation of the asset.

In some embodiments, an asset embodies or includes at least one sensor. Each sensor monitors at least one operational aspect of the asset. In this regard, as the asset operates, the sensor may determine, detect, measure, and/or otherwise capture data value(s) indicating a at least a portion of operational data associated with the operation of the asset. In this regard, the operational data may include data values for particular performance metrics tracked for a particular asset. Non-limiting of such performance metrics include operation speed of one or more component(s), average time to complete a task, and/or the like. In some embodiments, each sensor is embodied in hardware, software, firmware, and/or a combination thereof that detects or otherwise determines the data value for a particular performance metric associated with operation of the asset. For example, in some embodiments an asset includes an internal heat sensor, operational speed monitor for a particular component of the asset, and/or the like that is housed within or otherwise communicatively coupled to the asset itself during operation. In some other embodiments, an asset is associated with an external and/or otherwise separate sensor embodied in hardware, software, firmware, and/or a combination thereof, that detects or otherwise determines the data value for a particular performance metric associated with operation of the asset. For example, in some embodiments a camera, temperature gauge, pressure sensor, or other sensor monitors the output or environment surrounding at least one component of the asset to determine the particular performance metric during operation of that asset.

The asset management system 102 includes any number of computing device(s), system(s) embodied in hardware, software, and/or the like that performs generation of improved maintenance schedule(s) for one or more assets, and/or that performs any number of actions that process an improved maintenance schedule generated as described herein for at least one particular asset. In some embodiments, an asset management system 102 includes one or more specially configured application server(s), database server(s), end user device(s), cloud computing system(s), and/or the like. Additionally or alternatively, in some embodiments, the asset management system 102 includes one or more displays, peripherals, client devices, user devices, and/or the like, that enables access to functionality provided via the asset management system 102, for example via a web application, native application, and/or the like. In some embodiments, such functionality is handled by an external user device or other computing device, for example a user device 108.

In some embodiments, the asset management system 102 is specially configured to perform generation of an improved maintenance schedule for at least one asset. For example as illustrated, in some embodiments the asset management system 102 generates an improved maintenance schedule for at least the asset 106a. In this regard, the asset management system 102 nay generate an improved maintenance schedule for the asset 106a that includes maintenance events at particular maintenance periods determined to more accurately represent optimal timings for such maintenance events. Such determinations may be performed utilizing data-driven determinations based at least in part on data representing or derivable from actual performance of the asset, for example operational data and/or associated performance metrics. In some embodiments, the asset management system 102 generates an improved maintenance schedule for some combination or all of the assets 106a-106c. In this regard, a maintenance schedule may include various maintenance events for the various assets individually, or in consideration of the assets as a whole. As described herein, in some embodiments the asset management system 102 includes, maintains, or otherwise accesses an intelligence machine learning model specially configured to generate at least one maintenance schedule as described herein.

The optional asset alerting system 112 includes any number of computing device(s), system(s) embodied in hardware, software, and/or the like that performs monitoring of operations at least one particular asset, as described herein. In some embodiments, an asset alerting system 112 includes one or more specially configured application server(s), database server(s), end user device(s), cloud computing system(s), and/or the like. Additionally or alternatively, in some embodiments, the asset alerting system 112 includes one or more displays, peripherals, client devices, user devices, and/or the like, that enables access to functionality provided via the asset alerting system 112, for example via a web application, native application, and/or the like. In some embodiments, such functionality is handled by an external user device or other computing device, for example a user device 108. Additionally or alternatively, in some embodiments such functionality for outputting to a user is handled via another system communicable with the asset alerting system 112, such as the asset management system 102.

In some embodiments, the asset alerting system 112 is specially configured to perform asset operations monitoring and/or alerting for at least one asset. For example, as illustrated, in some embodiments the asset alerting system 112 performs asset monitoring for at least asset 106a. In this regard, the asset alerting system 112 may receive operational data associated with the asset 106a as the asset 106a operates, for example from the asset 106a itself or a sensor associated with the asset 106a. Additionally or alternatively, in some embodiments, the asset alerting system 112 generates and/or derives one or more performance metrics associated with the asset 106a based at least in part on the operational data. In some embodiments, the asset alerting system 112 includes or embodies one or more database(s) that store the operational data and/or performance metrics associated with the asset 106a.

In some embodiments, the asset alerting system 112 is specially configured to generate and/or trigger one or asset alerts based at least in part on monitored operation of the asset 106a. For example, in some embodiments, the asset alerting system 112 maintains at least one alert generation rule defining data-driven determinations, checks, and/or other processes that, when satisfied, trigger generation of an asset alert. In one example context, an alert generation rule includes particular equations or other processes based on data values represented in or derived from the operational data that indicate poor performance of the asset, malfunctioning of a particular subcomponent of the asset, and/or the like. In some embodiments, each generated asset alert is stored via the asset alerting system 112, for example such that the asset alerting system 112 generates and/or stores alert history data for a particular asset or plurality of assets. Additionally or alternatively, in some embodiments the asset alerting system 112 outputs the generated asset alert or a notification associated therewith to the asset management system 102, and/or an associated user device, such as user device 108, for further processing.

It should be appreciated that while the above is described with respect to monitoring the asset 106a, a plurality of assets may be similarly monitored. For example, in some embodiments, the asset alerting system 112 individually monitors each of the asset 106a, asset 106b, and asset 106c. Alternatively or additionally, in some embodiments, the asset alerting system 112 monitors collective data associated with the assets 106a-106c as a group.

The user device 108 includes any number of computing device(s), system(s) embodied in hardware, software, and/or the like that perform outputting of data associated with a maintenance schedule, or portion thereof, to a user. In some embodiments, the user is a maintenance worker or other entity responsible for performing maintenance actions associated with a particular asset. In some embodiments, a user device 108 includes one or more smartphones, tablets, laptops, personal computers, and/or other end-user devices. The user device 108 may be specially configured via particular software applications, including individual “apps” for example, that initiate the particular functionality as depicted and described herein. Additionally or alternatively, in some embodiments, the user device 108 includes another application server, intermediary computing device, and/or the like that routes output to a particular end user. In some embodiments, the user device 108 includes at least one display that facilitates output to an end user.

In some embodiments, the user device 108 is specially configured to perform output of notifications and/or other data associated with a maintenance schedule or particular maintenance event thereof. In some embodiments, the user device 108 outputs one or more advance notifications via a display of the user device 108. For example, the advance notification may be received from the asset management system 102 and/or generated based at least in part on data received from the asset management system 102. In this regard, the advance notification may indicate upcoming maintenance actions to be performed by the user of the user device 108 at a particular timestamp, for example represented by a maintenance period corresponding to a maintenance event including the maintenance actions within the maintenance schedule.

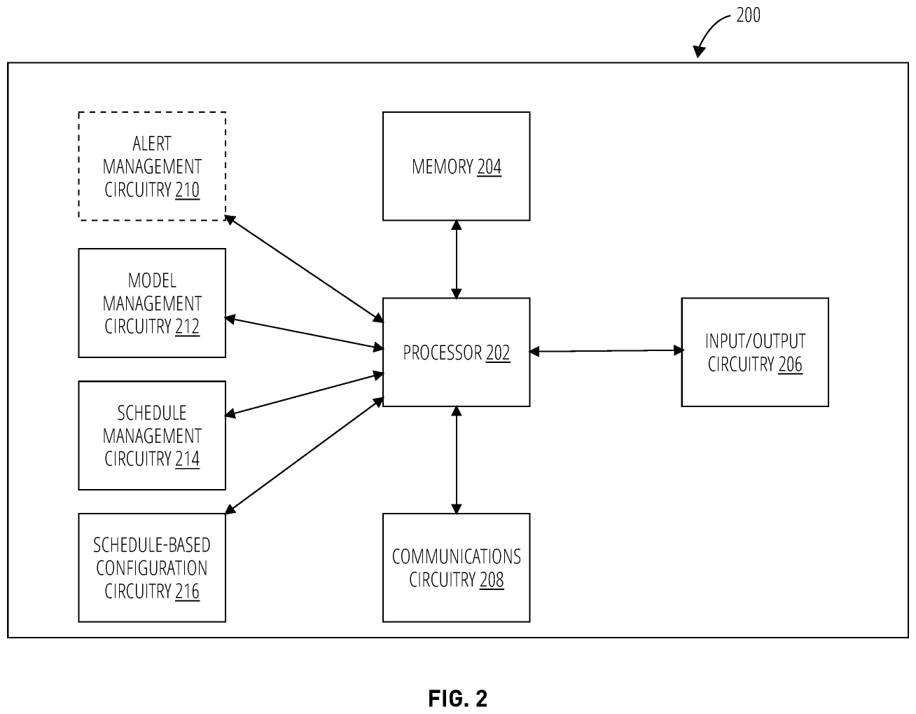

FIG. 2 illustrates a schematic diagram of an apparatus in accordance with at least one embodiment of the present disclosure. Specifically, FIG. 2 depicts an example asset management apparatus 200 (“apparatus 200”) specially configured in accordance with at least some example embodiments of the present disclosure. In some embodiments, the asset management system 102 and/or a portion thereof is embodied by one or more system(s), such as the apparatus 200 as depicted and described in FIG. 2. The apparatus 200 includes processor 202, memory 204, input/output circuitry 206, communications circuitry 208, alert management circuitry 210, model management circuitry 212, schedule management circuitry 214, and schedule-based configuration circuitry 216. In some embodiments, the apparatus 200 is configured, using one or more of the processor 202, memory 204, input/output circuitry 206, communications circuitry 208, alert management circuitry 210, model management circuitry 212, schedule management circuitry 214, and schedule-based configuration circuitry 216, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described here in.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with improved maintenance schedule generation and/or processing of the maintenance schedule. In some embodiments, the processor 202 includes hardware, software, firmware, and/or a combination thereof, that receiving input data utilized to generate an improved maintenance schedule. In some embodiments, the input data is received via retrieval from a database, maintaining of the input data via the apparatus 200, and/or receiving from an external device. In some embodiments, the input data includes (i) alert history data corresponding to an asset, (ii) maintenance standards data corresponding to the asset, (iii) service history data corresponding to the asset, and (iv) user-specific data corresponding to the asset. Additionally or alternatively, in some embodiments, the processor 202 includes hardware, software, firmware, and/or a combination thereof, that applies the input data to an intelligence machine learning model. The intelligence machine learning model is specially configured to generates a maintenance schedule based at least in part on the input data. In some embodiments, the apparatus 200 trains the intelligence machine learning model, and/or maintains the trained intelligence machine learning model for use. In some embodiments, the processor 202 includes hardware, software, firmware, and/or a combination thereof, that outputs a particular maintenance schedule corresponding to the asset. In some embodiments, the maintenance schedule is output from the intelligence machine learning model based at least in part on the input data. Additionally or alternatively, in some embodiments, the processor 202 includes hardware, software, firmware, and/or a combination thereof, that processes the maintenance schedule for any of additional processes, for example to generate and/or transmit at least one maintenance advance notification, automatically flag at least one performance metric associated with the asset as untrustworthy for at least one maintenance period, automatically toggling activation of at least one alert generation rule, and/or automatically initiating at least one maintenance action.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

The alert management circuitry 210 includes optional hardware, software, firmware, and/or a combination thereof, that supports performing generation and/or tracking of asset alerts. For example, in some embodiments, the alert management circuitry 210 includes hardware, software, firmware, and/or a combination thereof, that receives alert history data associated with at least one asset of a monitored environment. Additionally or alternatively, in some embodiments, the alert management circuitry 210 includes hardware, software, firmware, and/or a combination thereof, that receives and/or otherwise monitors operational data associated with at least one asset. Additionally or alternatively, in some embodiments, the alert management circuitry 210 includes hardware, software, firmware, and/or a combination thereof, that generates performance metrics based on received operational data for a particular asset. Additionally or alternatively, in some embodiments, the alert management circuitry 210 includes hardware, software, firmware, and/or a combination thereof, that determines whether an alert generation rule corresponding to the particular asset is satisfied. Additionally or alternatively, in some embodiments, the alert management circuitry 210 includes hardware, software, firmware, and/or a combination thereof, that generates an asset alert in a circumstance where at least one alert generation rule is satisfied. Additionally or alternatively, in some embodiments, the alert management circuitry 210 includes hardware, software, firmware, and/or a combination thereof, that maintains asset history data embodying or based at least in part on generated asset alerts for a particular asset. In some embodiments, the alert history data maintained by the alert management circuitry 210 includes data based on asset alerts for a plurality of assets. In some embodiments, the alert management circuitry 210 maintains alert history data for each asset of a plurality of assets. In some embodiments, the alert management circuitry 210 includes a separate processor, specially configured field programmable gate array (FPGA), or a specially programmed application specific integrated circuit (ASIC).

The model management circuitry 212 includes hardware, software, firmware, and/or a combination thereof, that supports training and/or maintenance of at least one model utilized in generation of an improved maintenance schedule. For example, in some embodiments, the model management circuitry 212 includes hardware, software, firmware, and/or a combination thereof, that maintains an intelligence machine learning model for use in generating a maintenance schedule. Additionally or alternatively, in some embodiments, the model management circuitry 212 includes hardware, software, firmware, and/or a combination thereof, that maintains at least one natural language processing model for use in processing and/or generating text data. Additionally or alternatively, in some embodiments, the model management circuitry 212 includes hardware, software, firmware, and/or a combination thereof, that applies particular data to the natural language processing model and/or natural language processing model. Additionally or alternatively, in some embodiments, the model management circuitry 212 includes hardware, software, firmware, and/or a combination thereof, that trains the intelligence machine learning model based at least in part on a set of training data. Additionally or alternatively, in some embodiments, the model management circuitry 212 includes hardware, software, firmware, and/or a combination thereof, that trains the natural language processing model. In some embodiments, the model management circuitry 212 includes a separate processor, specially configured field programmable gate array (FPGA), or a specially programmed application specific integrated circuit (ASIC).

The schedule management circuitry 214 includes hardware, software, firmware, and/or a combination thereof, that supports generation of an improved maintenance schedule. For example, in some embodiments, the schedule management circuitry 214 includes hardware, software, firmware, and/or a combination thereof, that generates a maintenance schedule based at least in part on received input data. In some embodiments, the schedule management circuitry 214 includes hardware, software, firmware, and/or a combination thereof, that applies input data to an intelligence machine learning model to generate the maintenance schedule. In some embodiments, the generated maintenance schedule includes one or more maintenance events, each maintenance event corresponding to a particular maintenance period during which one or more maintenance actions are to be performed. Additionally or alternatively, in some embodiments, the schedule management circuitry 214 includes hardware, software, firmware, and/or a combination thereof, that generates and/or output a maintenance item list corresponding to a particular asset to indicated receive maintenance. Additionally or alternatively, in some embodiments, the schedule management circuitry 214 includes hardware, software, firmware, and/or a combination thereof, that processes text data utilizing a natural language processing model to generate at least a portion of input data utilized by the intelligence machine learning model. In some embodiments, the schedule management circuitry 214 includes a separate processor, specially configured field programmable gate array (FPGA), or a specially programmed application specific integrated circuit (ASIC).

The schedule-based configuration circuitry 216 includes hardware, software, firmware, and/or a combination thereof, that supports performance of one or more processes based at least in part on a generated maintenance schedule. For example, in some embodiments, the schedule-based configuration circuitry 216 includes hardware, software, firmware, and/or a combination thereof, that generates an advance notification corresponding to an upcoming maintenance event represented in a maintenance schedule. Additionally or alternatively, in some embodiments, the schedule-based configuration circuitry 216 includes hardware, software, firmware, and/or a combination thereof, that automatically flag at least one performance metric associated with the asset as untrustworthy during a maintenance period associated with the asset, as represented in the maintenance schedule. Additionally or alternatively, in some embodiments, the schedule-based configuration circuitry 216 includes hardware, software, firmware, and/or a combination thereof, that automatically initiates at least one maintenance action associated with the asset, for example during a maintenance period in the maintenance schedule. Additionally or alternatively, in some embodiments, the schedule-based configuration circuitry 216 includes hardware, software, firmware, and/or a combination thereof, that automatically toggles activation of at least one alert generation rule based at least in part on the particular maintenance schedule. In some embodiments, the schedule-based configuration circuitry 216 includes a separate processor, specially configured field programmable gate array (FPGA), or a specially programmed application specific integrated circuit (ASIC).

Additionally or alternatively, in some embodiments, two or more of the sets of circuitries embodying processor 202, memory 204, input/output circuitry 206, communications circuitry 208, alert management circuitry 210, model management circuitry 212, schedule management circuitry 214, and/or schedule-based configuration circuitry 216 are combinable. Alternatively or additionally, in some embodiments, one or more of the sets of circuitry perform some or all of the functionality described associated with another component. For example, in some embodiments, two or more of the processor 202, memory 204, input/output circuitry 206, communications circuitry 208, alert management circuitry 210, model management circuitry 212, schedule management circuitry 214, and/or schedule-based configuration circuitry 216, are combined into a single module embodied in hardware, software, firmware, and/or a combination thereof. Similarly, in some embodiments, one or more of the sets of circuitry, for example the alert management circuitry 210, model management circuitry 212, schedule management circuitry 214, and/or schedule-based configuration circuitry 216, is/are combined with the processor 202, such that the processor 202 performs one or more of the operations described above with respect to each of the alert management circuitry 210, model management circuitry 212, schedule management circuitry 214, and/or schedule-based configuration circuitry 216.

### EXAMPLE DATA ENVIRONMENTS OF THE DISCLOSURE

Having described example systems and apparatuses in accordance with the disclosure, example data environments will now be described. In some embodiments, the example data environments include one or more software applications executed on particular hardware that facilitates the functionality described with respect to the particular data environment. For example, in some embodiments the data environments are embodied by software applications executed on the applications and/or systems described with respect to FIG. 1 and FIG. 2 to facilitate the functionality for generation of improved maintenance schedules and/or processing thereof. In some embodiments, the data environments include software-maintained data objects that are processed via computer-implemented methods implemented on such systems and/or apparatuses described herein.

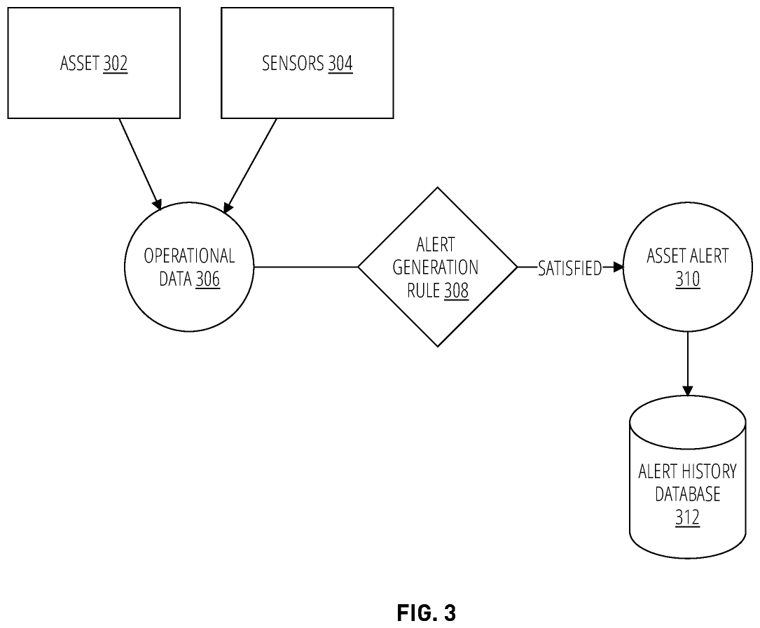

FIG. 3 illustrates a data flow for generating an asset alert in accordance with at least one embodiment of the present disclosure. Specifically, FIG. 3 depicts triggering generation of an asset alert associated with an asset 302. The asset 302 corresponds to one or more sensors 304, where the sensors 304 monitor operations of the asset 302 as the asset 302 is performing. In some embodiments, the asset 302 embodies a machine, robot, or other processing unit that operates as part of an industrial process performed in a monitored environment, for example where the industrial process creates a final product from one or more input products. In some embodiments, the sensors 304 include a pressure sensor, temperature sensor, movement sensor, rotational or linear speed sensor, a counting sensor (e.g., counting a number of outputs produced by the asset 302), and/or one or more custom sensors that detect any measurable value.

The asset 302 and/or the sensors 304 measure, detect, or otherwise generate operational data 306. In this regard, in some embodiments the operational data 306 include raw data values associated with operation of the asset 302. In some embodiments, the asset 302 and/or the sensors 304 provide operational data 306 in real-time as such data is determined via the asset 302 and/or sensors 304. In some embodiments, the asset 302 and/or sensors 304 transmit (e.g., via a wired and/or wireless communication network) the operational data 306 to a centralized monitoring system for processing, for example the asset management system 102 and/or asset alerting system 112. For example, in some embodiments the asset 302 and/or sensors 304 transmit the operational data 306 to the apparatus 200 for processing as depicted and described herein.

In some embodiments, the operational data 306 is processed to determine one or more data values for one or more performance metrics associated with the asset 302. In some embodiments, the performance metrics for a particular asset are predetermined. In some embodiments, for example, an asset type of the asset 302 is utilized to identify particular performance metrics associated with the asset 302. Additionally or alternatively, in some embodiments, the performance metrics associated with the asset 302 are determinable based at least in part on an identifier or other data specific to the asset 302.

The operational data 306, and/or performance metrics and/or other data derived therefrom, is processed by the alert generation rule 308. The alert generation rule 308 may include one or more data-driven determinations that, if satisfied, indicate a performance issue associated with the asset 302. For example, in some embodiments, the alert generation rule 308 includes one or more equations or conditionals that, when satisfied, indicate that the asset 302 is operating in a degraded state, non-functional, or otherwise undesirable state. In this regard, generation of asset alerts may indicate that the asset 302 is operating in a state that requires maintenance to return the asset 302 to a nominal or otherwise desirable operational state.

As illustrated, some embodiments such as the apparatus 200 generate the asset alert 310 in a circumstance where the alert generation rule 308 is satisfied. In some embodiments, the asset alert 310 includes data identifying the alert generation rule 308 that was satisfied, timestamp data for the time at which the alert generation rule 308 was satisfied or at which the operational data 306 was received that was then processed for satisfaction of the alert generation rule 308, and/or the like. Additionally or alternatively, in some embodiments, the asset alert 310 indicates a particular malfunction or problem determined or predicted to be affecting the asset 302 based at least in part on satisfaction of the alert generation rule 308. In some embodiments, a problem or malfunction associated with the asset 302 is determinable from a combination of asset alerts including at least the asset alert 310 and one or more other asset alerts generated corresponding to the asset 302.

In some embodiments, one or more notifications in response to the asset alert 310 are generated. For example, in some embodiments, generation of the asset alert 310 triggers a notification transmitted as a text message, user interface, email, or other data accessible by an end user via a user device. For example, in some embodiments, the notification associated with the asset alert 310 is generated identifying the particular asset alert 310 generated, the alert generation rule 308 that was satisfied, and/or indicating that maintenance of the asset 302 is required. The notification associated with the asset alert 310 in some embodiments is transmitted to the user device for outputting via at least one user interface rendered to a display of the user device.

Some embodiments store the asset alert 310 in an alert history database 312. In some embodiments, the apparatus 200 stores the asset alert 310 as part of alert history data maintained via the alert history database 312. In this regard, the alert history database 312 may store alert history data corresponding to each asset in at least one monitored environment, for example including at least the asset 302. In some embodiments, the alert history data for a particular asset includes each asset alert, for example the asset alert 310, generated corresponding to that particular asset. For example, the alert history database 312 may store first alert history data including each asset alert corresponding to the asset 302, second alert history data including each asset alert corresponding to a second asset, and the like. Additionally or alternatively, in some embodiments, an asset alert 310 is stored associated with a plurality of assets, for example in a circumstance where the alert generation rule 308 is indicative of a malfunction contributed to by a plurality of assets, for example assets of particular asset types and/or the like.

In some embodiments, the alert history database 312 is configured to store or otherwise includes one or more other portions of data associated with the asset alerts and/or satisfied alert generation rules that generated the asset alerts for a particular asset. For example, in some embodiments, the alert history database 312 includes data identifying the corresponding alert generation rule that was satisfied to trigger generation of an asset alert. Additionally or alternatively, in some embodiments, the alert history database 312 maintains data linking an asset alert and/or an alert generation rule with one or more service case recommendations associated with that asset alert and/or alert generation rule. In some embodiments, each service case recommendation represents a particular maintenance action recommended to perform as part of maintenance of the asset to resolve a determined operational issue associated with the asset as indicated by the asset alert and/or satisfied alert generation rule.

The alert history database 312 may be accessible to the apparatus 200 for further processing, for example to retrieve particular alert history data during generation of a maintenance schedule. In some embodiments, the apparatus 200 generates and/or maintains the alert history database 312 in as depicted and described in FIG. 3. In some embodiments, the alert history database 312 is maintained by a separate system, for example embodied by the asset alerting system 112 as described herein, and made available to the apparatus 200 for processing at least during generation of a maintenance schedule.

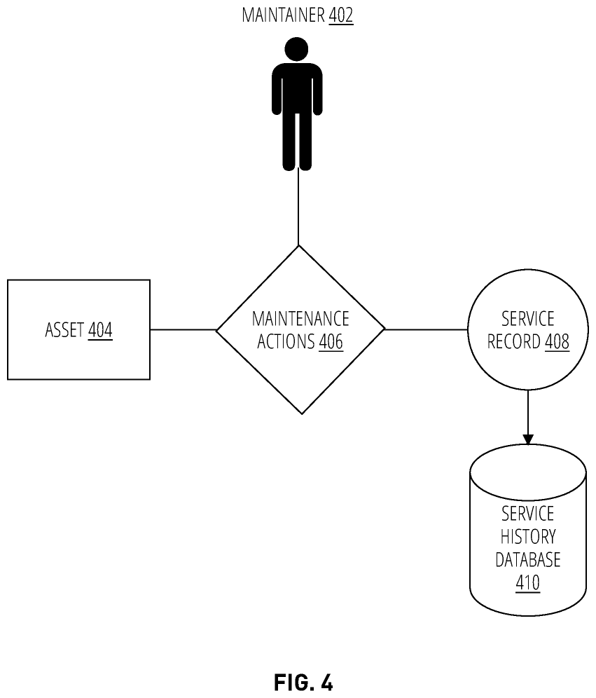

FIG. 4 illustrates a data flow for generating a service record in response to a performed maintenance event in accordance with at least one embodiment of the present disclosure. Specifically, FIG. 4 depicts generation of a service record in response to maintenance performed for a particular asset 404. The asset 404 in some embodiments corresponds to at least one previously generated asset alert indicating that the asset 404 requires maintenance. In some embodiments for example, the asset 404 is embodied by the asset 302 for which at least one asset alert 310 was generated as depicted and described with respect to FIG. 3. For example, in some embodiments, a maintainer 402 performs maintenance in response to a received notification triggered based at least in part on generation of the alert generation rule 308. Additionally or alternatively, in some embodiments, a maintainer 402 performs maintenance in accordance with a generated maintenance schedule, for example during one or more maintenance events represented in a maintenance schedule generated as described herein or otherwise.

In some embodiments, the maintainer 402 embodies a user, human, or other entity that physically interacts with the asset 404 to perform particular maintenance on the asset 404. In this regard, in some such embodiments the maintainer 402 engages, replaces, updates, reconfigures, or otherwise interacts with one or more subcomponents of the asset 404. Additionally or alternatively, in some embodiments, the maintainer 402 replaces the asset 404 itself within a physical space. In some embodiments, the maintainer 402 embodies a user, human, or other entity that remotely interacts with the asset 404, for example via a digital interface or otherwise over one or more communications networks. In this regard, the maintainer 402 may upgrade, patch, alter, or otherwise reconfigure one or more settings, properties, or other aspects of the asset 404 that affect operation of said asset 404. For example, in some embodiments, the maintainer 402 embodies a remote manager or remote maintenance employee located within a central monitoring environment that interacts with the asset 404 located in a remote, monitored environment. Non-limiting examples of such aspects configurable during remote maintenance includes operational parameter values for a particular property utilized to control operation of the asset 404, command(s) for execution by the asset 404, software instructions and/or applications utilized to update the asset 404, and/or new software to install and/or execute via the asset 404.

The maintainer 402 interacts with the asset 404 to perform one or more maintenance actions 406. The maintenance actions 406 in some embodiments are part of a particular maintenance event. The maintenance event may be scheduled, for example as part of a generated or otherwise determined maintenance schedule. Alternatively or additionally, in some embodiments the maintenance events are performed in response to one or more asset alerts, for example indicating emergency maintenance of the asset 404 is required. It will be appreciated that maintenance actions may be performed by a maintainer, such as maintainer 402, on an asset for any reason. The maintenance actions 406 may include any number of actions that adjust, reconfigure, or otherwise maintain an asset 404. Non-limiting examples of maintenance actions 406 include replacement of the asset 404 or a subcomponent thereof, reconfiguration of one or more aspects of the asset 404 or a subcomponent thereof, updating of software executed by or that controls operation of the asset 404, and/or the like.

Some embodiments generate a service record 408 in response to the maintenance actions 406. In some embodiments, the apparatus 200 or another system such as the asset alerting system 112 automatically generates the service record 408 upon detecting completion of the maintenance actions 406. Additionally or alternatively, in some embodiments the maintainer 402 inputs data to the apparatus 200 or an associated system to generate the service record 408. For example, the service record 408 may include data identifying each of the maintenance actions 406 that were completed by the maintainer 402, timestamp data indicating when such maintenance actions were performed, and/or the like. In this regard, the service record 408 embodies a digital record of maintenance actions performed during a particular maintenance event.

Some embodiments store the service record 408 in a service history database 410. In some embodiments, the apparatus 200 stores the service record 408 as part of service history data associated with the asset 404 maintained by the service history database 410. In this regard, the service record 408 may store service history data for each asset in at least one monitored environment, for example including at least asset 404. In some embodiments, the service history data for a particular asset includes each service record, for example service record 408, generated corresponding to that particular asset. For example, the service history database 410 may store first service history data including each service record corresponding to the asset 404, second service history data including each service record corresponding to a second asset, and the like. Additionally or alternatively, in some embodiments, the service record 408 is stored associated with a plurality of assets, for example in a circumstance where maintenance is performed for a plurality of assets during a single maintenance event defined corresponding to a particular maintenance period.

The service history database 410 may be accessible to the apparatus 200 for further processing, for example to retrieve particular service history data during generation of a maintenance schedule. In some embodiments, the apparatus 200 generates and/or maintains the service history database 410 as depicted and described in FIG. 4. In some embodiments, the service history database 410 is maintained by a separate system, for example embodied by the asset alerting system 112 as described herein, and made available to the apparatus 200 for processing at least during generation of a maintenance schedule.

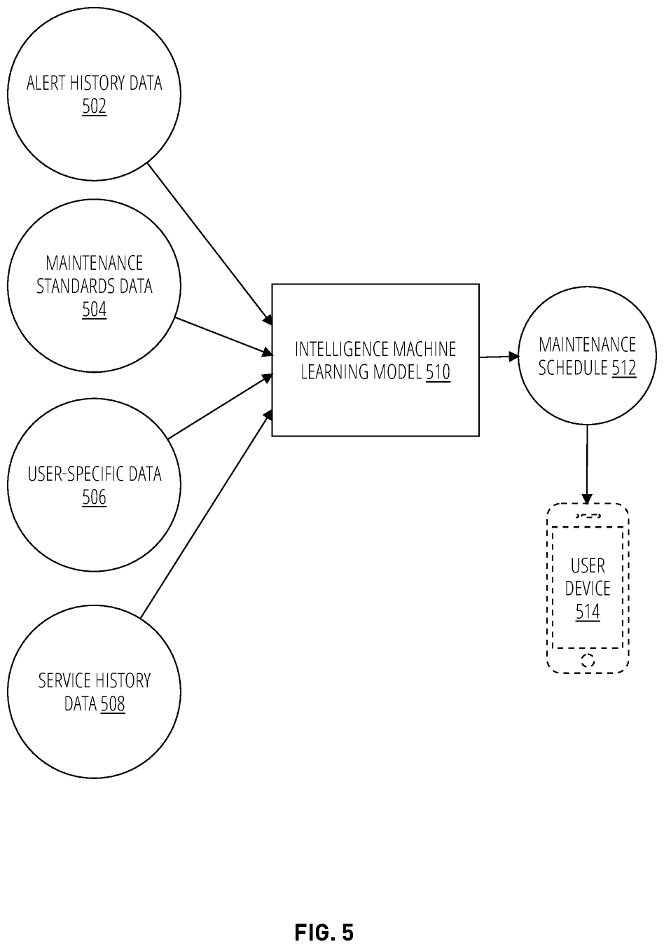

FIG. 5 illustrates a data flow for generating a maintenance schedule in accordance with at least one embodiment of the present disclosure. Specifically, FIG. 5 depicts generation of a maintenance schedule 512 via input data applied to a specially configured intelligence machine learning model 510. For example, in some embodiments the apparatus 200 performs generation of a maintenance schedule via the depicted data flow for at least one asset. Additionally or alternatively, in some embodiments, the apparatus 200 performs the depicted data flow to generate a maintenance schedule for a plurality of assets.

FIG. 5 depicts a plurality of portions of input data including alert history data 502, maintenance standards data 504, user-specific data 506, and service history data 508. In some embodiments, one or more portions of the input data are predetermined or otherwise statically available to the apparatus 200, for example at least the maintenance standards data 504. Additionally or alternatively, in some embodiments, one or more portions of the input data is retrievable and/or received from a database that is accessible to the apparatus 200 and stores historical data. For example, in some embodiments, the apparatus 200 accesses the alert history database 312 to receive the alert history data 502 and/or service history database 410 to receive the service history data 508.

Additionally or alternatively, in some embodiments the apparatus 200 maintains or accesses one or more databases storing maintenance standards data 504 associated with one or more assets. For example, in some embodiments, the maintenance standards data 504 includes a knowledge base defining a predetermined maintenance schedule for one or more assets, asset types, and/or the like. The maintenance standards data 504 may include accepted or otherwise agreed upon standards for a maintenance schedule for assets of various asset types, for example where the maintenance schedule is agnostic of the specific functionality of a particular asset. In this regard, the maintenance standards data 504 in some embodiments defines a default maintenance schedule and/or rules for defining when particular maintenance events should take place and/or what particular maintenance actions should be performed during such particular maintenance events. In some embodiments, the maintenance standards data 504 is received from an external system embodying a trusted source of such data, and/or is stored and updateable by one or more subject matter experts or other particular users associated with the entity operating the assets of the monitored environments. In some embodiments, the maintenance standards data 504 embodies a legacy data set.

Additionally or alternatively, in some embodiments the apparatus 200 maintains or accesses one or more databases storing user-specific data 506. In some embodiments, the user-specific data 506 is maintained by the apparatus 200. Additionally or alternatively, in some embodiments, the apparatus 200 receives at least a portion of the user-specific data 506 from an external system, database, and/or the like. In some embodiments, the user-specific data 506 is maintained by a control system, central monitoring system, and/or entity IT system corresponding to one or more assets being monitored. For example, a particular entity in some embodiments has at least one server that stores user-specific data corresponding to assets within at least one particular monitored environment associated with that entity.

In some embodiments, the user-specific data 506 includes user inputted text data associated with maintenance of one or more assets, a plurality of assets, and/or asset types. For example, in some embodiments, the user-specific data 506 includes data (e.g., text data) embodying user-defined overrides of default maintenance standards represented in the maintenance standards data 504. Additionally or alternatively, in some embodiments, the user-specific data 506 includes user-defined notes associated with a previously-defined maintenance schedule, maintenance of a specific asset or plurality of assets, and/or the like. In some embodiments, an administrator, maintainer, or other user associated with the apparatus 200 inputs such text data directly via the apparatus 200.

In some embodiments, the input data made available to the intelligence machine learning model 510 includes metadata associated with an asset. The metadata may include data indicating particular an operational status, particular parameter value, and/or other operational data associated with the asset as a whole. Additionally or alternatively, in some embodiments the metadata associated with an asset includes one or more portions of metadata associated with a part of the asset. For example, in some embodiments, the asset metadata includes an operational status, particular parameter value, and/or other operational data associated with each part of one or more monitored parts of an asset. The part may be a subcomponent of the asset that enables functioning of the asset itself.

In some embodiments, one or more portions of the input data is processed via at least one natural language processing model for applying to the intelligence machine learning model 510. For example, in some embodiments, one or more of the alert history data 502, maintenance standards data 504, user-specific data 506, and/or service history data 508 is processed via at least one natural language processing model to generate machine-interpretable data corresponding to the text data in a portion of the input data. For example, in some embodiments the apparatus 200 processes the maintenance standards data 504 to generate machine-interpretable data embodying a default or predetermined maintenance schedule, processes the user-specific data 506 to generate machine-interpretable data embodying user inputted requirements for adjustments to a default maintenance schedule defined by the maintenance standards data 504, and/or generate data embodying performed maintenance actions and/or effects of the maintenance actions from the service history data 508. The machine-interpretable data may be applied to the intelligence machine learning model 510 for use in generating at least a particular maintenance schedule based at least in part on the input data.

In some embodiments, the intelligence machine learning model 510 includes a specially configured machine learning model, rule set, algorithmic model, and/or the like. The intelligence machine learning model 510 is specially configured to generate at least an improved maintenance schedule, such as the maintenance schedule 512, based on the input data applied to said intelligence machine learning model 510. For example, in some embodiments, the intelligence machine learning model 510 is specially configured during a training phase to generate a maintenance schedule 512 that includes any number of maintenance events, the maintenance events scheduled in accordance with particular maintenance periods and each maintenance events including particular maintenance actions that are indicated for performance during the maintenance event. In some embodiments, the intelligence machine learning model 510 generates each maintenance action indicated for performance associated with a particular maintenance event, and generates the maintenance period represented at least in part by timestamp data embodying a start time for the maintenance event. For example, the intelligence machine learning model 510 may be specially configured to learn an optimal length of time between maintenance events and/or particular maintenance actions based at least in part on the input data, and/or otherwise learn data patterns, trends, and/or other information indicating that maintenance is needed based on the combination input data portions. In some embodiments, each maintenance event comprises or otherwise is associated with a set of one or more maintenance actions to be performed by a maintainer. The maintenance event may include or otherwise be associated with one or more remotely performable maintenance actions, and/or one or more non-remotely performable maintenance actions (e.g., that require a maintainer to physically interact with the asset in the real-world, including by remote control robots or via the maintainer themselves).

In some embodiments, the intelligence machine learning model 510 processes one or more portions of the input data at least in part utilizing a natural language processing model. For example, in some embodiments the apparatus 200 processes text data of the maintenance standards data to generate machine-interpretable data associated with a default or otherwise predefined maintenance schedule for one or more assets. Additionally or alternatively, in some embodiments, the apparatus 200 processes text data of the user-specific data to generate machine-interpretable data associated with user notes, overrides, and/or other data associated with modification of a default or otherwise predetermined maintenance schedule, for example represented by the maintenance standards data. Additionally or alternatively, in some embodiments, the apparatus 200 processes text data of service history data to generate machine-interpretable data associated with completed maintenance events for one or more assets, performed maintenance action for the one or more assets, and/or the like. In this regard, in some embodiments the apparatus 200 inputs the machine-interpretable data generated from the portions of input data to the intelligence machine learning model in place of the raw data of the input data portions.

In some embodiments, the intelligence machine learning model 510 is trained by the apparatus 200. Additionally or alternatively, in some embodiments, the intelligence machine learning model 510 is trained by an external system that provides the apparatus 200 access to the trained intelligence machine learning model 510, or provides the intelligence machine learning model 510 upon completion of training to the apparatus 200 for storage. In some embodiments, the intelligence machine learning model 510 is trained based at least in part on a training data set including training data values for each portion of the input data as depicted and described with respect to FIG. 5. It will be appreciated that the intelligence machine learning model 510 may be trained utilizing supervised learning techniques, for example based at least in part on labeled input data indicating a maintenance event and corresponding maintenance period for an asset based on a portion of training data, and/or unsupervised learning techniques.

The input data is applied to an intelligence machine learning model 510 as input to cause the intelligence machine learning model 510 to generate the maintenance schedule 512 based at least in part on the intelligence machine learning model 510. For example, in some embodiments the apparatus 200 applies the alert history data 502, maintenance standards data 504, user-specific data 506, and service history data 508 to the intelligence machine learning model 510 to generate the maintenance schedule 512, where the alert history data 502, maintenance standards data 504, user-specific data 506, and service history data 508 are all associated at least in part with a particular asset. Additionally or alternatively, in some embodiments, the input data apparatus 200 applies metadata associated with the asset, including any metadata associated with one or more parts of the asset, and/or other data identifying or otherwise associated with an asset. For example, in some embodiments, the input data includes one or more portions of data for a particular asset embodying an asset type, asset make, asset model, asset warranty status, asset last service details, asset current problems identified by one or more service case, standard maintenance needs for the asset, and/or data representing the sensors and other subcomponents present in the asset.

In some embodiments, the maintenance schedule 512 embodies a particular schedule of maintenance events for the particular asset. Additionally or alternatively, in some embodiments, the maintenance schedule 512 includes supporting information associated with maintenance to be performed for the particular asset. For example, in some embodiments, the maintenance schedule 512 includes data assisting a technician to plan performance of the maintenance on the asset, data indicating particular maintenance actions defining how to maintain the asset, available parts embodying a subcomponent of the asset, planning for acquiring parts of the asset, and/or data integrating with one or more vendor management system that enables selection of a particular part for replacing in the asset.

In some embodiments, the apparatus 200 stores the maintenance schedule 512. Additionally or alternatively, in some embodiments the apparatus 200 processes the maintenance schedule 512 as part of one or more processes, as described herein. Additionally or alternatively still, in some embodiments, the apparatus 200 outputs the maintenance schedule 512. For example, in some embodiments, the maintenance schedule 512 outputs some or all of the maintenance schedule 512 via a user device 514. In some embodiments, the user device 514 embodies an end terminal, display, or other computing device accessible to a maintenance coordinator that assigns maintainers or otherwise initiates maintenance events at the particular corresponding maintenance periods. Additionally or alternatively, in some embodiments the user device 514 embodies an end terminal, display, or other computing device accessible to a maintainer intended to perform at least one maintenance event represented in the maintenance schedule 512.

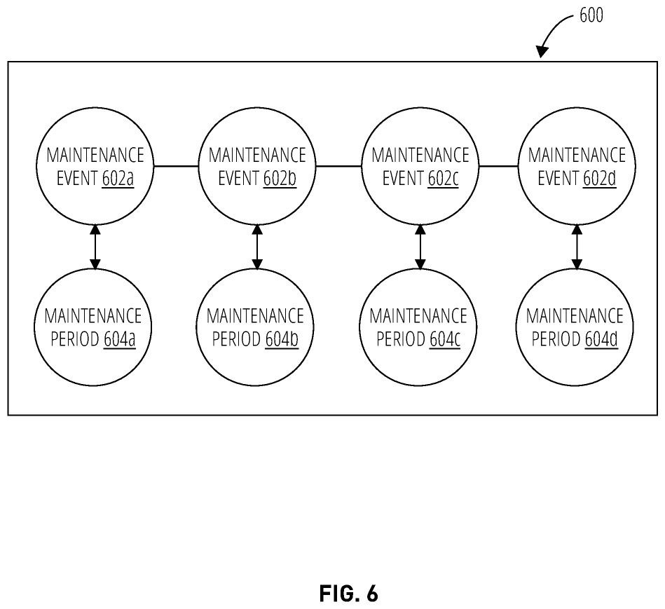

FIG. 6 illustrates a visualization of an example maintenance schedule in accordance with at least one embodiment of the present disclosure. Specifically, FIG. 6 depicts an example maintenance schedule 600 representing a plurality of scheduled maintenance events, specifically maintenance event 602a, maintenance event 602b, maintenance event 602c, and maintenance event 602d. In some embodiments, the maintenance schedule 600 is embodied by a single data object including data portions or sub-objects corresponding to each of the maintenance event 602a-602d. Additionally or alternatively, in some embodiments, the maintenance schedule 600 is embodied by a plurality of distinct data objects, for example a database embodying each maintenance event and corresponding maintenance period as a distinct data record in the database. In some embodiments, the maintenance schedule 600 is generated as depicted and described with respect to FIG. 5. Although depicted as distinct items, it will be appreciated that in some embodiments a maintenance event includes data embodying the maintenance period during which the maintenance event is to be performed or initiated.

In some embodiments, the maintenance schedule 600 includes data for one or more maintenance events, each maintenance event indicating performance of particular maintenance of an asset to be performed. In some embodiments, each portion of data embodying a maintenance event includes data embodying one or more maintenance actions to be performed during the particular maintenance. Additionally or alternatively, in some embodiments, the maintenance actions determined are based at least in part on service case recommendations associated with particular generated asset alerts, alert generation rules that were triggered associated with a particular asset or plurality of assets, and/or the like. For example, such data may be determinable based at least in part on alert history data associated with at least one asset. In some embodiments, each portion of data embodying a maintenance event includes or is associated with data identifying a particular maintainer assigned to perform the maintenance of an asset associated with the maintenance event.

As illustrated, the maintenance schedule 600 includes a first maintenance event 602a. The first maintenance event 602a is associated with a first maintenance period 604a. The maintenance period 604a embodies timestamp data embodying when the corresponding maintenance event 602a is to be performed or initiated. In some embodiments, the maintenance period 604a embodies or includes timestamp data representing a start time at which the maintenance event 602a is to be initiated. In some embodiments, the maintenance period 604a includes or embodies timestamp data representing a start time of the maintenance period 604a and an end time of the maintenance period 604a.

In this regard, it will be appreciated that the maintenance event 602b is similarly associated with maintenance period 604b, maintenance period 604c is associated with maintenance period 604c, and maintenance period 604d is associated with maintenance period 604d. Each of the maintenance periods may indicate that the timestamp data specific to the corresponding maintenance event. In a circumstance where the maintenance schedule 600 is associated with a particular asset, for example, the maintenance period 604a may represent a first time period during which a first maintenance of the asset is scheduled to occur, and the maintenance period 604b may represent a second time period during which a second maintenance of the asset is scheduled to occur, and so on. In this regard, the maintenance events 602a, 602b, 602c, and 604d may be scheduled at particular times determined by an intelligence machine learning model to optimize one or more parameters.

In some other embodiments, for example where the maintenance schedule 600 is associated with a plurality of assets, each maintenance event may be associated with a distinct asset of the plurality of assets. For example, the maintenance event 602a may correspond to a first asset, whereas the maintenance event 602b corresponds to a second asset, the maintenance event 602c corresponds to a third asset, and the maintenance event 602d corresponds to a fourth asset. In this regard, the corresponding maintenance period for each such maintenance event may represent a particular time during which maintenance of the corresponding asset of the plurality of assets is to be initiated or to be performed. For example, in some such embodiments, maintenance period 604a embodies or includes timestamp data indicating when maintenance event 602a is to be performed for a first asset, the maintenance period 604b embodies or includes timestamp data indicating when maintenance event 602b is to be performed for the second asset, and so on. In this regard, the maintenance schedule 600 may be utilized to optimize maintenance performance for a plurality of assets individually, or for optimization of maintenance performed for the plurality of assets as a whole. For example, an intelligence machine learning model may optimize the maintenance schedule 600 to optimize operations of all such assets based on constrained resources available for such maintenance, such as constraints on maintainers to perform the maintenance, costs of maintenance actions scheduled to be performed as part of the maintenance events, and/or the like.

In some embodiments, the maintenance schedule 600 includes data indicating particular maintainers, users, and/or the like assigned to or otherwise linked to a particular maintenance event. For example, in some embodiments, a user assigns a particular maintainer to a particular maintenance event, such that data identifying the maintainer is stored corresponding to the particular maintenance event. Additionally or alternatively, in some embodiments, the apparatus 200 or a particular component thereof, for example the intelligence machine learning model, assigns a particular maintainer to the maintenance event.

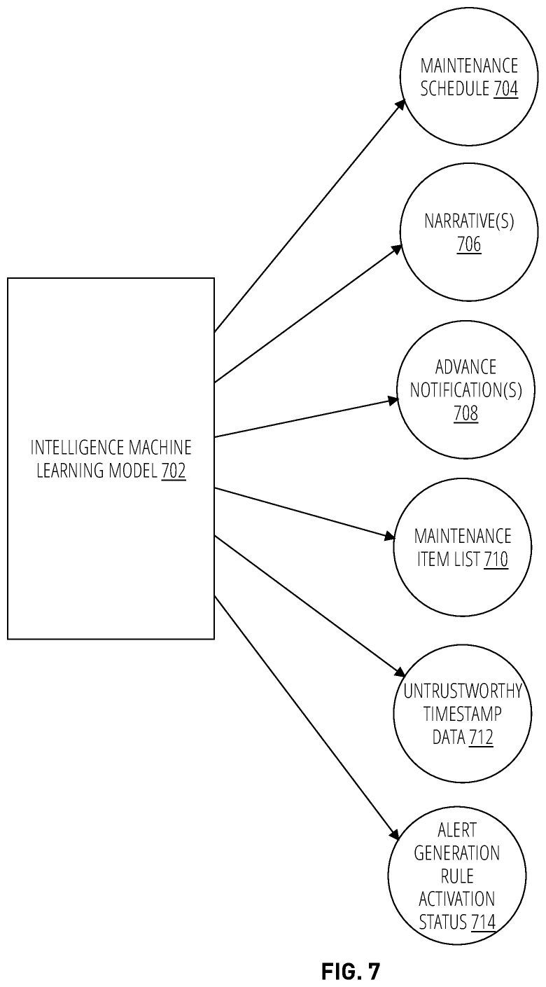

FIG. 7 illustrates a visualization of various example data generable via an intelligence machine learning model in accordance with at least one embodiment of the present disclosure. Specifically, FIG. 7 depicts various types of data that may be generated and/or outputted by an intelligence machine learning model in accordance with the present disclosure. For example, the apparatus 200 may maintain intelligence machine learning model 702 for outputting one or more of the particular types of output data depicted and described with respect to FIG. 7 based at least in part on particular input data applied to the intelligence machine learning model 702. In some embodiments, the intelligence machine learning model 702 embodies a particular implementation of the intelligence machine learning model 510, for example where any of the data depicted and described with respect to FIG. 7 may be outputted together with the maintenance schedule 512 depicted and described with respect to FIG. 5. In some such embodiments, the maintenance schedule 704 embodies the maintenance schedule 512 as depicted and described with respect to FIG. 5. In some other embodiments, the apparatus 200 generates one or more of the narratives 706, advance notifications 708, maintenance item list 710, untrustworthy timestamp data 712, and/or alert generation rule activation status 714 utilizing at least one distinct post-process upon completion of generating the maintenance schedule 704 via the intelligence machine learning model 702.

As illustrated in FIG. 7, in some embodiments, the intelligence machine learning model 702 generates the one or more narratives 706, for example based at least in part on the maintenance schedule 704. In some embodiments, each narrative of the narratives 706 embodies human-readable text data associated with the generated maintenance schedule, for example embodied by the maintenance schedule 704. In some embodiments, a narrative includes data representing explanations of why maintenance events in the maintenance schedule 704 were generated and/or why such maintenance events are scheduled at particular times represented by a maintenance period corresponding to a particular maintenance event. For example, such explanations may be derived by the intelligence machine learning model 702 based at least in part on the input data and/or learnings of the intelligence machine learning model 702 utilized to generate the maintenance schedule 704. Additionally or alternatively, in some embodiments, a narrative includes text data indicating changes for a particular asset from maintenance standards data, and/or user-specific data, to maintenance events represented in the maintenance schedule 704 for a particular asset, and/or an explanation of such changes. In some embodiments, the intelligence machine learning model 702 automatically derives one or more of the narratives 706 during execution of the intelligence machine learning model 702 for generation of the maintenance schedule 704, for example to reflect particular activations of the intelligence machine learning model 702 that resulted in generation of the maintenance schedule 704. The narratives 706 may be stored, further processed, and/or transmitted for outputting to a particular user device, display of the apparatus 200, and/or the like. In some embodiments, the narrative(s) 706 are generated at least in part using at least one natural language processing model, for example to generate a narrative that is in a natural language format for displaying to a user.

Additionally or alternatively, in some embodiments, the intelligence machine learning model 702 generates one or more advance notifications 708, for example based at least in part on the maintenance schedule 704. In some embodiments, an advance notification embodies renderable data associated with a particular maintenance event that indicates the maintenance event is associated with a maintenance period at a future timestamp. In some embodiments, for example, the intelligence machine learning model 702 generates an advance notification upon determining that future timestamp data representing a maintenance period for a particular maintenance event in the maintenance schedule 704 is within a particular threshold time interval from a current timestamp. In some embodiments, each of the advance notifications 708 is transmitted to a user device associated with a particular maintainer assigned or otherwise determined to perform the maintenance event, or a display of the apparatus 200. In some such embodiments, the advance notifications 708 is renderable via the user device or display as display as a user interface, push notification, email, text message, or other interface depicted in a native application associated with accessing functionality of the apparatus 200, or a third-party application providing access to particular texts, emails, or other data transmissions embodying the advance notifications 708.

Additionally or alternatively, in some embodiments, the intelligence machine learning model 702 generates at least one maintenance item list 710, for example based at least in part on the maintenance schedule 704. In some embodiments, the maintenance item list 710 includes a set of one or more actions for a maintainer to perform to diagnose problems and/or otherwise maintain a particular asset associated with the maintenance item list 710. For example, in some embodiments the maintenance item list 710 includes one or more actions that enable a maintainer to confirm particular subcomponents of the asset that are malfunctioning, configurations that may be affecting performance of the asset, and/or otherwise identify a root cause of one or more performance issues associated with operation of the asset. Additionally or alternatively, in some embodiments, the maintenance item list 710 includes any number of maintenance actions to perform for a particular asset. In this regard, in some embodiments the maintenance item list 710 embodies a checklist of interactions, engagements, and/or other actions to be performed by a particular maintainer during a maintenance event associated with a particular asset.

Additionally or alternatively, in some embodiments, the intelligence machine learning model 702 generates at least one untrustworthy timestamp data 712, for example based at least in part on the maintenance schedule 704. In some embodiments, the untrustworthy timestamp data 712 embodies timestamp data representing a particular interval of time during which at least one performance metric associated with an asset is untrustworthy. For example, during the time interval represented by the untrustworthy timestamp data 712, the at least one performance metric may be affected by maintenance of the asset, such that the data value generated for that performance metric during the time interval is not accurate. In some embodiments, the untrustworthy timestamp data 712 corresponds to all or at least a particular portion of the maintenance period corresponding to a particular maintenance event represented in the maintenance schedule 704. Additionally or alternatively, in some embodiments, the intelligence machine learning model 702 generates other data that otherwise excludes particular data, such as operational data or other telemetry data sensed or otherwise derived from operation of the asset undergoing maintenance, in one or more KPI calculations. In this regard, the one or more KPIs may instead be generated without using such data to enhance the accuracy of the generated KPIs.

Additionally or alternatively, in some embodiments, the intelligence machine learning model 702 causes toggling of at least one alert generation rule activation status 714, for example based at least in part on the maintenance schedule 704. In some embodiments, the alert generation rule activation status 714 corresponds to at least one particular alert generation rule, wherein the alert generation rule is utilized to generate asset alert(s) based at least in part on received operational data associated with an asset. In this regard, the alert generation rule activation status 714 may be toggled to a first state that causes activation of at least one alert generation rule, such that the alert generation rule may be utilized to generate one or more asset alerts while activated. Additionally or alternatively, the alert generation rule activation status 714 may be toggled to a second state that causes deactivation of the at least one alert generation rule. In this regard, the alert generation rule may not be triggered while in a second, deactivated state. For example, in some embodiments, the intelligence machine learning model 702 generates alert generation rule activation status 714 to cause deactivation of at least one alert generation rule associated with a particular asset, or associated with at least one performance metric associated with an asset, during all or at least some of a maintenance period associated with the asset as represented in the maintenance schedule 704. Similarly, the intelligence machine learning model 702 may generate alert generation rule activation status 714 that causes activation of the at least one alert generation rule after completion of a maintenance period represented in the maintenance schedule 704. Additionally or alternatively, in some embodiments the alert generation rule activation status 714 causes deactivation of at least one alert generation rule during a time interval represented by untrustworthy timestamp data 712, and/or causes activation of the at least one alert generation rule upon completion of the time interval represented by the untrustworthy timestamp data 712.

### EXAMPLE PROCESSES OF THE DISCLOSURE

Having described example systems and apparatuses, data representations and visualizations, and data flows in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

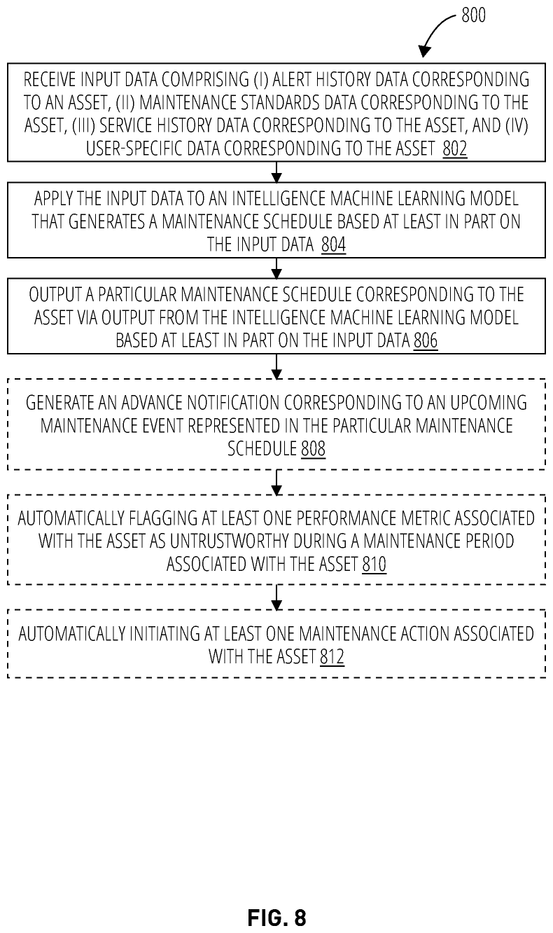

FIG. 8 illustrates operations of an example process in accordance with at least one embodiment of the present disclosure. Specifically, FIG. 8 depicts operations of an example process 800. In some embodiments, the process 800 is embodied by computer program code stored on a non-transitory computer-readable storage medium of a computer program product configured for execution to perform the process as depicted and described. Alternatively or additionally, in some embodiments, the process 800 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one apparatus, at least one physical component, at least one processing plant system, a scheduling system, and/or the like. For purposes of simplifying the description, the process 800 is described as performed by and from the perspective of the apparatus 200.

According to some examples, the method includes receiving input data corresponding to the asset at operation 802. In some embodiments, the apparatus 200 receives at least a portion of the input data from a database maintained by the apparatus 200. Additionally or alternatively, in some embodiments the apparatus 200 receives at least a portion of the input data from at least one external system, for example directly from the at least one system or from a database configured to be written to by the at least one external system. Additionally or alternatively, in some embodiments, the apparatus 200 receives at least a portion of the input data as statically maintained data accessible to the apparatus 200.

In some embodiments, the input data includes at least (i) alert history data corresponding to an asset, (ii) maintenance standards data corresponding to the asset, (iii) service history data corresponding to the asset, and/or (iv) user-specific data. In some embodiments, the alert history data includes data representing at least one asset alert previously generated corresponding to the asset generated by the apparatus 200 and/or an external system, for example based at least in part on operational data received from the asset. In some embodiments, the maintenance standards data includes data representing particular generally accepted or industry-standard requirements for maintaining a particular asset and/or particular asset type. In some embodiments, the maintenance standards data embodies data generated or otherwise maintained by a particular entity, for example that defines the maintenance requirements for that particular entity specifically. Alternatively or additionally, in some embodiments, the maintenance standards data includes publicly available or otherwise accessible data standards for maintenance requirements.

In some embodiments, the service history data includes data representing at least one service record previously generated corresponding to the asset as generated by the apparatus 200 and/or an external system. In some embodiments, a user embodying a maintainer inputs data embodying or utilized to generate the service record that is stored for a particular asset, for example based at least in part on an asset identifier inputted by the user. Alternatively or additionally, in some embodiments at least a portion of the service history data is generated automatically by the apparatus 200 or an external system. For example, in some embodiments, the service history data is stored at least in part on one system, and other data, for example manual maintenance instances performed by a user are recorded in data records stored by another system. The apparatus 200 in some embodiments consolidates such data records for processing to generate the maintenance schedule for one or more assets.

In some embodiments, the user-specific data represents user-inputted notes and/or other data associated with one or more assets. In some embodiments, the user-specific data includes text data that is processable by one or more natural language processing models, for example where the text data is in a natural language format. In this regard, the natural language processing model processes the text data to generate machine-interpretable data corresponding to such text data, for example that may not be in a natural language format.

According to some examples, the method includes applying the input data to an intelligence machine learning model at operation 804. The intelligence machine learning model generates a maintenance schedule based at least in part on the input data applied to the intelligence machine learning model. In some embodiments, the maintenance schedule includes one or more maintenance events scheduled at particular maintenance periods. Each maintenance event may define one or more maintenance actions to be performed during the particular corresponding maintenance period. In some embodiments, the intelligence machine learning model generates the maintenance schedule that optimizes one or more target parameters, for example minimizing resource expenditure and/or maintenance needs for a particular asset or plurality of assets without sacrificing significant output or completion of an industrial process to which the assets contribute, for example.

According to some examples, the method includes outputting a particular maintenance schedule corresponding to the asset via output from the intelligence machine learning model based at least in part on the input data at operation 806. In this regard, in some embodiments the particular maintenance schedule embodies the output generated by the intelligence machine learning model upon applying of the portions of input data to the intelligence machine learning model. In some embodiments, the apparatus 200 outputs the maintenance schedule to a display of the apparatus 200 for rendering via one or more user interfaces. Additionally or alternatively, in some embodiments the apparatus 200 outputs the maintenance schedule via one or more transmissions to a user device for rendering via a display of the user device. Additionally or alternatively, in some embodiments the apparatus 200 outputs the maintenance schedule as data for further processing by the apparatus 200 or one or more associated systems communicable with the apparatus 200.

According to some examples, the method includes generating an advance notification corresponding to an upcoming maintenance event represented in the particular maintenance schedule at optional operation 808. In some embodiments, the advance notification is associated with a maintenance event associated with a maintenance period that represents a future time. In this regard, the advance notification in some embodiments provides a notification or reminder of an upcoming maintenance event to be performed, for example when the maintenance event is scheduled for a maintenance period represented by timestamp data to begin within a threshold period of time from the current timestamp. In some embodiments, the advance notification is generated and outputted to a display of the apparatus 200. Alternatively or additionally, in some embodiments, the apparatus 200 outputs the advance notification via transmission to one or more user device to cause rendering of the advance notification to the user device.

According to some examples, the method includes automatically flagging at least one performance metric associated with the asset as untrustworthy during a maintenance period associated with the asset at optional operation 810. For example, in some embodiments the apparatus 200 determines a time or time interval represented by the maintenance period corresponding to a maintenance event represented in the maintenance schedule. The apparatus 200 in some such embodiments generates flags the particular at least one performance metric as untrustworthy during such a time or time interval. In some embodiments, the marking of a performance metric as untrustworthy causes rendering of a notification or interface element that indicates that the performance metric may not be representative of true performance of the asset or assets in circumstances where the performance metric is rendered to a dashboard or other reporting interface. In some embodiments, the marking of a performance metric as untrustworthy causes the apparatus 200 or an associated system to ignore the performance metric during the maintenance period for one or more subsequent or downstream processes, for example reporting processes, monitoring processes, and/or the like.

According to some examples, the method includes automatically initiating at least one maintenance action associated with the asset at optional operation 812. In some embodiments, the at least one maintenance action corresponds to a particular maintenance event represented in the generated maintenance schedule. For example, the apparatus 200 may determine one or more maintenance actions defined in a scheduled maintenance event is remotely performable automatically via connection with a particular asset, and initiate the maintenance action automatically during the maintenance period. Additionally or alternatively, in some embodiments, the apparatus 200 automatically initiates the maintenance action in response to user input authorizing automatic inhiation of the maintenance action. In this regard, the automatically performed maintenance actions may reduce the resource expenditure required for maintainers to perform such maintenance actions.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for generating a dynamic maintenance schedule for at least one asset comprising:
receiving input data comprising (i) alert history data corresponding to an asset, (ii) maintenance standards data corresponding to the asset, (iii) service history data corresponding to the asset, and (iv) user-specific data corresponding to the asset,
applying the input data to an intelligence machine learning model that generates a maintenance schedule based at least in part on the input data; and
outputting a particular maintenance schedule corresponding to the asset via output from the intelligence machine learning model based at least in part on the input data.

2. The computer-implemented method of claim 1, wherein the particular maintenance schedule indicates at least one subcomponent of the asset indicated to receive maintenance, and wherein the particular maintenance schedule particular timestamp data indicating a time at which maintenance of the asset is to be performed.

3. The computer-implemented method of claim 1, wherein the intelligence machine learning model further outputs at least one narrative associated with the maintenance schedule,
wherein the at least one narrative comprises first text data indicating a first reason for deviating at least one maintenance event in the maintenance schedule from the maintenance standards data, second text data indicating a second reason for an arrangement of maintenance events represented in the maintenance schedule, or a combination of the first text data and the second text data.

4. The computer-implemented method of claim 3, wherein the intelligence machine learning model comprises at least one natural language processing model that generates the at least one narrative in a natural language format.

5. The computer-implemented method of claim 1, wherein the intelligence machine learning model further generates a maintenance item list corresponding to the asset.

6. The computer-implemented method of claim 1, further comprising:
generating an advance notification corresponding to an upcoming maintenance event represented in the particular maintenance schedule.

7. The computer-implemented method of claim 1, further comprising:
automatically flagging at least one performance metric associated with the asset as untrustworthy during a maintenance period associated with the asset, wherein the maintenance period is represented by the particular maintenance schedule.

8. The computer-implemented method of claim 1, further comprising:
automatically toggling activation of at least one alert generation rule based at least in part on the particular maintenance schedule.

9. The computer-implemented method of claim 1, further comprising:
automatically initiating at least one maintenance action associated with the asset.

10. The computer-implemented method of claim 1, wherein the intelligence machine learning model comprises at least one natural language processing model that determines at least a portion of the user-specific data corresponding to the asset based at least in part on text data stored by a user associated with the asset.

11. The computer-implemented method of claim 1, wherein the input data comprises asset metadata comprising metadata associated with the asset or metadata associated with at least one part of the asset.

12. An apparatus comprising:
at least one processor; and
at least one memory storing computer-coded instructions that, when executed by the at least one processor, cause the apparatus to:
receive input data comprising (i) alert history data corresponding to an asset, (ii) maintenance standards data corresponding to the asset, (iii) service history data corresponding to the asset, and (iv) user-specific data corresponding to the asset,
apply the input data to an intelligence machine learning model that generates a maintenance schedule based at least in part on the input data; and
output a particular maintenance schedule corresponding to the asset via output from the intelligence machine learning model based at least in part on the input data.

13. The apparatus of claim 12, wherein the particular maintenance schedule indicates at least one subcomponent of the asset indicated to receive maintenance, and wherein the particular maintenance schedule particular timestamp data indicate a time at which maintenance of the asset is to be performed.

14. The apparatus of claim 12, wherein the intelligence machine learning model further outputs at least one narrative associated with the maintenance schedule,
wherein the at least one narrative comprises first text data indicate a first reason for deviating at least one maintenance event in the maintenance schedule from the maintenance standards data, second text data indicating a second reason for an arrangement of maintenance events represented in the maintenance schedule, or a combination of the first text data and the second text data.

15. The apparatus of claim 14, wherein the intelligence machine learning model comprises at least one natural language processing model that generates the at least one narrative in a natural language format.

16. The apparatus of claim 12, wherein the instructions further cause the apparatus to:
generate an advance notification corresponding to an upcoming maintenance event represented in the particular maintenance schedule.

17. The apparatus of claim 11, wherein the instructions further cause the apparatus to:
automatically flag at least one performance metric associated with the asset as untrustworthy during a maintenance period associated with the asset, wherein the maintenance period is represented by the particular maintenance schedule.

18. The apparatus of claim 11, wherein the instructions further cause the apparatus to:
automatically toggle activation of at least one alert generation rule based at least in part on the particular maintenance schedule.

19. The apparatus of claim 11, wherein the instructions further cause the apparatus to:
automatically initiate at least one maintenance action associated with the asset.

20. A computer program product comprising at least one non-transitory computer-readable storage medium, the at least one non-transitory computer-readable storage medium including computer program code that when executed by at least one processor, configures the at least one processor to:
receive input data comprising (i) alert history data corresponding to an asset, (ii) maintenance standards data corresponding to the asset, (iii) service history data corresponding to the asset, and (iv) user-specific data corresponding to the asset,
apply the input data to an intelligence machine learning model that generates a maintenance schedule based at least in part on the input data; and
output a particular maintenance schedule corresponding to the asset via output from the intelligence machine learning model based at least in part on the input data.
